(19) United States
(12) Patent Application Publication
(10) Pub. No.: US 2009/0057256 A1
(43) Pub. Date: Mar. 5, 2009

(54) Nursing bottleholder improvement

(76) Inventor: Karen Song, Amarillo, TX (US)

Correspondence Address: STRASBURGER & PRICE, LLP, 901 MAIN STREET, SUITE 4400, DALLAS, TX, 75202, US

(21) Appl. No.: 12/231,400

(22) Filed: Sep. 2, 2008

Related U.S. Application Data
(60) Provisional application No. 60/966,856, filed on Aug. 30, 2007.

(51) Int. Cl. A61J 9/00; B65D 23/00; A47D 15/00; A01K 9/00; A01K 7/00; A61J 9/06

(52) U.S. Cl. 215/11.1; 215/395; 248/102; 119/71; 119/72

(57) ABSTRACT

An improvement to a nursing system for baby animals including a soft cylinder or rope-like extension detachably affixed to fabric sleeve or toroidal donut shaped ring surrounding a nipple-topped nursing bottle. The soft-cylinder or rope-like extension may be formed into a platform for the nipple-topped nursing bottle to enable baby animals to obtain liquid from the nipple-topped nursing bottle without assistance. Alternatively, the soft cylinder or rope-like extension provides a resting place for the baby animals or a series of surfaces on which the baby animal may climb to position itself where it can obtain liquid from the nipple-topped nursing bottle.

### CROSS REFERENCE TO RELATED APPLICATION

This application claims the benefit of Provisional U.S. Patent Application No. 60/966,856, filed Aug. 30, 2007.

### STATEMENT REGARDING FEDERALLY FUNDED RESEARCH AND DEVELOPMENT

The invention described in this patent application was not the subject of federally-sponsored research or development.

### FIELD

The present invention is an improvement to a system used for nursing a baby animal; more particularly the present invention is a system for enhancing the willingness of a baby animal to obtain nourishment by drinking fluid contained in a nipple-topped nursing bottle.

### BACKGROUND

The basic system for enhancing the willingness of baby animals to drink from a nipple-topped nursing bottle is described in my prior U.S. Pat. No. 6,772,891. A first improvement to the basic system appears in my pending U.S. patent application Ser. No. 11/396,523, filed Apr. 3, 2006. Both U.S. Pat. No. 6,772,891 and U.S. patent application Ser. No. 11/396,523 filed Apr. 3, 2006 are incorporated herein by reference.

Experiences with the Comfort Grip Bottle Holder described in my U.S. Pat. No. 6,772,891 have revealed that many orphaned baby animals that would have died from lack of nourishment are now alive because of the Comfort Grip Bottle Holder. Specifically, the Comfort Grip Bottle Holder provided what was needed for an orphaned baby animal to take nourishment from a nipple-topped nursing bottle. However, experience with the Comfort Grip Bottle Holder revealed that improvements were needed to further enhance its acceptance by baby animals and its usability by the human caretaker nursing the baby animal. The first of these improvements were described in my now-pending U.S. patent application Ser. No. 11/396,523, filed Apr. 3, 2006.

Described in my now-pending U.S. patent application Ser. No. 11/396,523 filed Apr. 3, 2006 is the use of toroidal ring positioned around the Comfort Grip Bottle Holder. It has been found that some orphaned nursing baby animals will not take nourishment from a nipple-topped nursing bottle unless a provision is made for the orphaned nursing baby animal to move its paws in a manner similar to the way a nursing baby animal kneads the breast of a nursing female animal. For many orphaned baby animals, the use of the toroidal ring around the Comfort Grip Bottle Holder overcomes their reluctance to drink from a nipple-topped nursing bottle. Accordingly, as with my initial invention, many orphaned baby animals who would have died from malnutrition from not taking nourishment from a nipple-topped nursing bottle are now alive and flourishing because of the addition of a toroidal ring around the Comfort Grip Bottle Holder.

Despite the dramatic improvements in caring for baby animals provided by my earlier inventions, it has been discovered that some newly-born orphaned baby animals, particularly those baby animals with large heads and short front legs, continue to experience difficulty using a nipple-topped nursing bottle even when covered with fabric and surrounded by a toroidal ring. This difficulty occurs because the size of the baby animal's head does not allow the baby animal's short front legs to reach the toroidal ring for kneading. In other situations some baby animals are born premature, others are born sick and still others are born with missing or deformed limbs. Heretofore these animals have had difficulty nursing from a nipple-topped nursing bottle.

Yet another problem occurs when young animals are taken away from their mother at an early age. This problem is well-known to those who have acquired a new puppy or a new kitten. Specifically, the baby animals rest for only short periods of time and when awake, make crying noises that keep their human caretakers awake during normal rest periods.

Accordingly, a need remains in the art for a system and method which will allow baby animals heretofore unable to take fluid from a nipple-topped nursing bottle to nurse and for a system which will allow the caretakers of baby animals to rest.

### SUMMARY

The nipple-topped nursing bottle Holder improvement of the present invention overcomes the difficulties experienced by baby animals who are unable to obtain nutrition from a nipple-topped nursing bottle and provides a method for those caretakers of baby animals to avoid having their rest interrupted by a hungry baby animal that is unable to gain access to a nipple-topped nursing bottle.

The disclosed improvement for systems to facilitate the feeding of orphaned baby animals who are unable to nurse from nipple-topped nursing bottles includes an expandable fabric sleeve portion covering the bottle portion of the nipple-topped nursing bottle. Surrounding the expandable fabric sleeve portion is an optional slidable, squeezable toroidal ring which may be positioned along the length of the nursing bottle. Further included are one or more flexible cylinders or soft rope-like extensions which are attachable to either the fabric sleeve portion or the toroidal ring. By knotting, curling or twisting the one or more flexible cylinders or soft rope-like extensions under the nipple-topped nursing bottle near the baby animal—a place is provided for the baby animal to climb, to rest its head, toward the nipple-topped nursing bottle and to knead with its front paws while drinking from nipple-topped nursing bottle during or after nursing. (If the length of the baby animal's front legs will not allow reaching incomplete the toroidal ring.) Use of the disclosed improvement to my baby animal nursing system has revealed that baby animals unwilling or unable to nurse can now take nutrition when desired and do not have to wake up their human caretakers for handfeeding whenever they are hungry.

### BRIEF DESCRIPTION OF THE FIGURES

A better understanding of the disclosed improvement to my baby animal nursing system of the present invention may be had by reference to the attached drawing figures wherein:

FIG. 1 is a perspective view of a nipple-topped nursing bottle within a nursing bottleholder;

FIG. 2 is a side elevational view of the rope-like extension.

FIG. 3 is a side elevational view of the rope-like extension with knots tied therein;

FIG. 4 is a perspective view of a nursing bottleholder with a knotted rope-like extension positioned thereunder.; and

FIG. 5 is a top plan view of multiple bottleholders in a baby animal bed.

### DESCRIPTION OF THE EMBODIMENTS

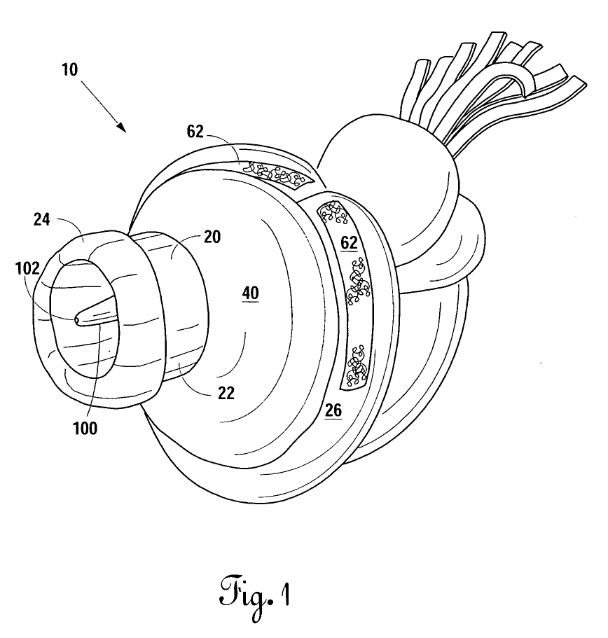

By reference to FIG. 1, a baby animal nursing system 10 for a nipple-topped nursing bottle 100 is shown. The nipple-topped nursing bottle 100 is positioned within a bottleholder 20 as described in my U.S. Pat. No. 6,772,891 and a toroidal donut-shaped ring 40 as described in my pending U.S. patent application Ser. No. 11/396,523, filed on Apr. 3, 2006. Those involved in the care of baby animals know that nipple-topped nursing bottles 100 for animals are available in a variety of different sizes from a variety of different suppliers, including the PetAg Company.

The baby animal nursing system 10 includes three parts.

The first part of the baby animal nursing system 10 is an expandable fabric sleeve portion 22 which is sized to cover and fit snugly around the fluid-containing portion of the nursing bottle 100 as the baby animals front legs become longer. As in my prior U.S. Pat. No. 6,772,891, the top of the fabric sleeve includes a small collar or ring 24 into which baby animals may place their nose and mouth when drawing liquid from the nursing bottle 100 through the nipple 102.

The second portion is a cylindrical substantially toroidal-shaped donut piece 40. The cylindrical substantially toroidal-shaped donut piece 40 is sized to fit snugly around the expandable sleeve portion 20 so that it will stay in place with respect thereto but loose enough so that it may be slid along the length of the sleeve portion surrounding the nursing bottle 100. The toroid-shaped donut piece 40 is positioned where the claws on the front paws of the baby animals can easily knead the toroidal-shaped donut piece 40 while the baby animal is nursing. As previously indicated, the substantially toroidal-shaped donut piece 40 is described more fully in my pending U.S. patent application Ser. No. 11/396,523, filed on Apr. 3, 2006.

It has been found that when some baby animals are quite small, such as baby animals who have been orphaned shortly after being born, the substantially toroidal-shaped donut piece 40 must be placed near the nipple on top of the nursing bottle. However for baby animals with large heads and short front legs, for prematurely-born baby animals, or for baby animals that are sick or for those baby animals having weak/inoperable limbs, the toroidal ring may not be satisfactory.

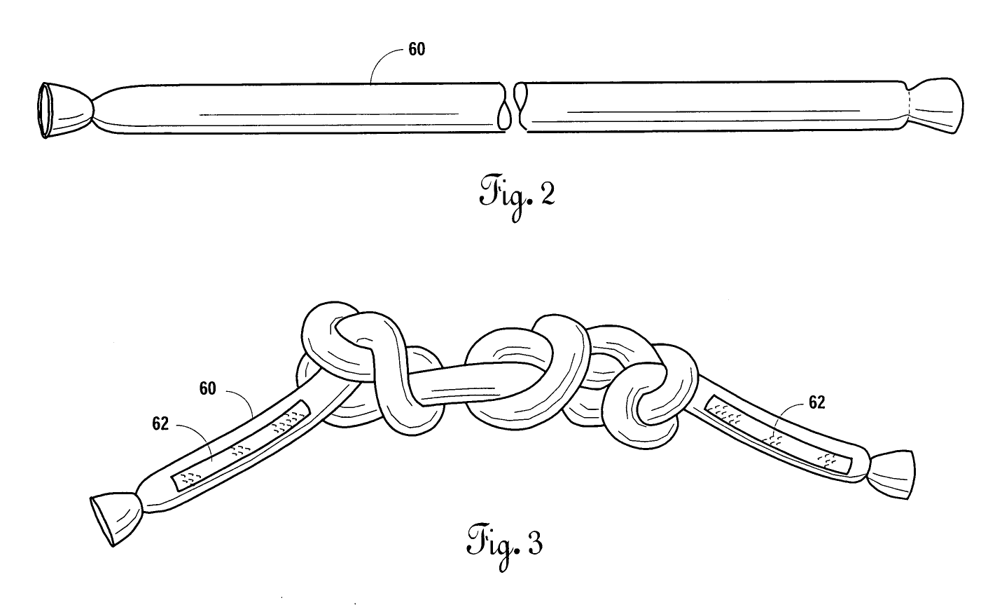

To meet the needs of baby animals otherwise unable to nurse from a nipple-topped nursing bottle 100 or to knead the toroidal ring 40, one or more long flexible cylinders or short rope-like extensions 60, as shown in FIG. 2, have been added to the nursing bottleholder assembly 10. The one or more long flexible cylinders or soft rope-like extensions 60 are attachable to a collar 26 formed on the bottom of the toroidal-shaped donut piece 40 using snaps, zippers, hook and eye fasteners, Velcro® 62, elastic bands, large loops, or any other attachment system known to those of ordinary skill in the art. Alternatively, the long flexible cylinders or soft rope-like extensions 60 may attach directly to the expandable sleeve portion or they may be left unattached.

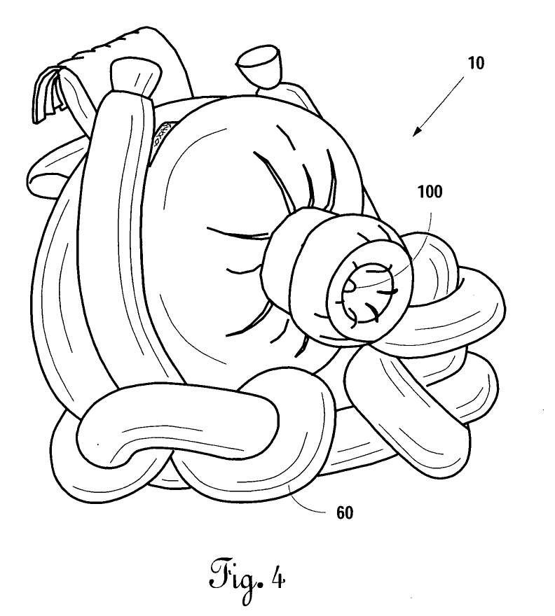

It has been found that by making the flexible cylinder 60 or soft rope-like extensions of sufficient length and suppleness to enable knotting, twisting or braiding the flexible cylinder or soft rope-like extension 60, as shown in FIG. 3, a support may be created for both the baby animal and the nipple-topped nursing bottle 100.

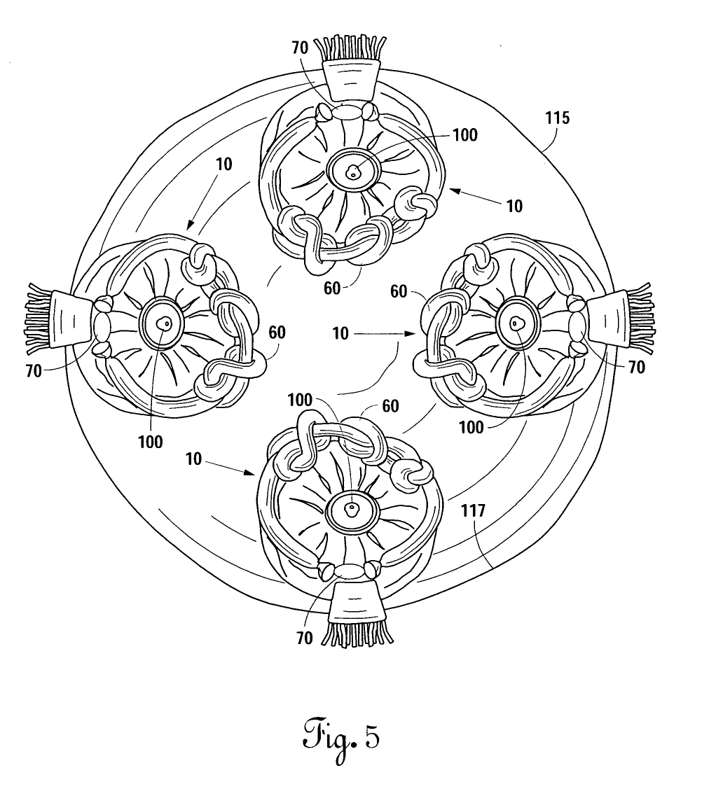

One way of using the flexible cylinder or soft rope-like extensions 60 as support for the nipple-topped nursing bottle 100 is shown in FIG. 4. If a single flexible cylinder or soft rope-like extension 60 is used, it can be either wrapped around the nursing bottle Holder assembly 10 or coiled under or wrapped around the baby animal. Accordingly, the user is able to configure one or more flexible cylinders or soft rope-like extensions 60 into a variety of different baby animal and/or nipple-topped nursing bottle support arrangements. As previously indicated, the placement of the flexible cylinder or soft rope-line extensions provide a baby animal with the ability to knead with its front paws while nursing if the baby animal cannot reach the toroidal ring 40.

The softness or squeezability of the one or more flexible cylinders or soft rope-like extensions 60 may be adjusted, based on the size and strength of the front paws or legs of the baby animal to enhance the willingness of the baby animal to take liquid from the nipple-topped nursing bottle 100. Further, the multiple array of surfaces and spaces formed by the knotted, twisted or braided flexible cylinders or soft rope-like extensions 60, as shown in FIG. 3 and FIG. 4, may be used to provide a resting place for the head or body of the baby animal. The size, specifically, the length or diameter of the flexible cylinders or soft rope-like extensions 60, may be adjusted as the baby animal grows. Those of ordinary skill in the art will understand that the flexible cylinders or soft rope-like extensions 60 may also be formed to include lumps or branches. Alternatively, the flexible cylinders or soft rope-like extensions may be tapered to provide yet greater utility for the baby animals.

Because the sense of smell is so important to baby animals for recognition of either a safe condition or a dangerous condition, the fabric used to cover the flexible cylinders or soft rope-like extensions 60 may be pre-scented so that the baby animal may recognize its own smell, the smell of its mother or the smell of its siblings. Alternatively, the skin of a similar animal may be used to cover the flexible cylinders or soft rope-like extensions 60. For example, sheepskin may be used if the disclosed invention 10 is being used to nurse a young lamb.

In another embodiment, it is possible to stuff the flexible cylinder or soft rope-like extension 60 with warmable material. The warmable material may be heated to the temperature of a nursing mother animal to relax the baby animal while feeding.

In those situations in which baby animals are reluctant to nurse from a nipple-topped nursing bottle 100, it has been found that an additional external stimulus may be required. Such additional external stimulus may be provided by a means for causing a gentle pulsing or low level of vibration within the flexible cylinders or soft rope-like extension 60 which gentle pulsing simulates either the pulsing of a mother's heart or the feel of a mother's body.

In yet other situations, a rhythmic sound provided by a means for producing sounds simulating of the beating of a mother's heart along with the pulsing sensations may provide the needed sensory input to encourage a baby animal to take milk or liquid from a nipple-topped nursing bottle 100.

In still yet another embodiment, means for producing low out put of light. Lights, such as LED's, may be used with the disclosed invention 10 to provide a visible stimulus to assist the baby animal in locating the nipple portion 102 of the nipple-topped nursing bottle 100.

Those of ordinary skill in the art will also understand that multiple numbers of the baby animal nursing systems 10 may be linked together by using the rope-like extensions 60. If multiple baby animal nursing systems 10 are linked together, multiple baby animals may cluster together as if they were nursing from a mother animal. Alternatively, multiple baby animal nursing systems 10 may be linked in either a cylindrical array in the center of a bed for multiple baby animals or attached in a linear fashion to the walls of a baby animal bed. In yet other situations, multiple baby animal nursing systems 10 may be hung from a net positioned over baby animals.

Shown in FIG. 5 is a substantially circular baby animal bed 115 with multiple baby animal nursing systems to affixed to the walls 117 of the baby animal bed 115. The baby animal nursing system 10 may be attached to wall 117 using Velcro®, snaps, hooks, or ties. In FIG. 5 the baby animal system 10 is attached to wall 117 by use of a ring 70. In this configuration, the baby animals will be able to crawl up to the nipple-topped nursing bottles 100 to nurse.

While the present invention has been described according to its use with baby animals, those human infants having difficulty transitioning to bottle feeding can be helped by the disclosed invention as well. Specifically, human infants appear to nurse better from a nipple-topped nursing bottle if they have an object placed at a location where their hands, fingers, feet, and toes can be used to position their bodies in a comfortable position while nursing. Accordingly, all the features and embodiments of the disclosed invention also have utility with decreasing the reluctance of human infants to take milk or other liquid through the nipple portion 102 of a nipple-topped nursing bottle 100.

As indicated above, a key part of the nursing process is increasing the satisfaction and pleasure given to the animal caretaker who is nursing either a baby animal or a human infant using a nipple-topped nursing bottle 100. One method of increasing the satisfaction and pleasure of the person nursing either a baby animal or a human infant is to enhance the visual and tactile feedback obtained during the nursing processing. Such visual feedback may be obtained by decorating the one or more flexible cylinders or rope-like extensions 60 with fringe, or by using colorful or patterned fabrics.

In other situations, a cluster of baby animal nursing system 10 may be placed together on a pillow or on a coil formed from a single flexible cylinder or soft rope-like extension 60 to enable substantially simultaneous feeding by baby animals.

In yet other situations, a cluster of individual baby animal nursing systems 10 may be placed in an animal nursery bag if transport of one or more baby animals is required. The size of the baby animal nursery bag is large enough to accommodate several baby animals along with the cluster of individual baby animal nursing systems 10. Net-covered openings may be provided in the baby animal nursery bag to allow the caretaker to observe the baby animals during transport.

Use of the products disclosed herein in various settings has produced an interesting result, particularly when children are present. Specifically, children observing the nursing of baby animals have expressed a desire to use small scale products identical to those disclosed herein with their toy animals. Accordingly, smaller versions of the disclosed invention suitable for use by children as toys are included within this disclosure.

Those of ordinary skill in the art will understand that the disclosed invention provides the following advantages:

the need for holding baby animals to feed them with a nipple-topped nursing bottle is eliminated, thereby freeing animal caretakers for other tasks and eliminating the danger of being clawed by the baby animals while nursing;

the soft cylinder or rope-like extension may be eventually configured by the baby animal being nursed to its own liking for proper positioning and comfort;

the ability to obtain nutrition from a nipple-topped nursing bottle is provided for orphaned baby animals of a variety of sizes, for premature baby animals and for sick or crippled baby animals;

the baby animals will be able to gain access to a nipple-topped nursing bottle when food is needed and not when a caretaker happens to be available for holding and feeding the baby animal;

multiple nursing bottle systems may be configured to resemble a mother animal;

the size of the disclosed baby animal nursing system is easily changed as the baby animal grows;

the soft cylinder or rope-like extension may be used to secure the baby animal nursing system to an animal unable to from its own body;

the soft cylinder or rope-like extension encourages baby animals to develop a tactile path encouraging them to climb to the nipple-topped nursing bottle, thus causing baby animals to use weak or underdeveloped muscles;

the baby animal may be secured in position or cushioned by the soft cylinder or rope-like extension thus preventing falling onto a hard surface if the baby animal falls asleep while nursing;

the soft cylinder or rope-like extension may be used as both a pillow and a blanket to provide greater comfort for the baby animal; and

the soft cylinder or rope-like extension may provide a place for a baby animal to knead with its paws while nursing.

While the disclosed invention has been described according to its preferred and alternate embodiments, those of ordinary skill in the art will understand that numerous other embodiments have been enabled by the foregoing description.

What is claimed is:

1. A holder for use with a nipple-topped nursing bottle, said holder comprising:
an expandable fabric sleeve portion for covering the nipple-topped nursing bottle;
one or more flexible cylinders or soft rope-like extensions attachable in close proximity to said expandable fabric sleeve portion;
wherein a baby animal or a human infant is able to either rest a portion of its body on said one or more flexible cylinders or soft rope-like extensions while receiving fluid from said nipple-topped nursing bottle.

2. The holder as defined in claim 1 further including a toroidal donut-shaped ring constructed and arranged for positioning around said expandable fabric sleeve portion.

3. A method for nursing a baby animal or human infant comprising the steps of:
filling a nipple-topped nursing bottle with a nursing fluid;
covering said nipple-topped nursing bottle with a fabric sleeve;
bringing one or more flexible cylinders or soft rope-like extensions into close proximity with said fabric sleeve;
moving said one or more flexible cylinders or soft rope-like extensions into a position with respect to said nursing bottle where the baby animal or human infant can be positioned on said flexible cylinder or soft rope-like extensions while nursing.

4. The method as defined in claim 3 further including the step of placing a toroidal ring over said fabric sleeve.

5. An improvement for device for feeding a baby animal from a nipple topped nursing bottle enclosed in an expandable fabric sleeve wherein the improvement comprises:
one or more flexible cylinders or soft-rope like extensions detachably affixed to said expandable fabric sleeve;
said one or more flexible cylinders or soft-rope like extensions having sufficient length and suppleness to be coiled, knotted or braided to provide support said nipple-topped nursing bottle.

6. The improvement as defined in claim 5 wherein said one or more flexible cylinders include a warmable material.

7. The improvement as defined in claim 5 wherein said flexible cylinders include a means for causing vibrations.

8. The improvement as defined in claim 5 wherein said flexible cylinders include a means for producing sounds.

9. The improvement as defined in claim 5 wherein said flexible cylinders include a means for producing light.

10. A system for enabling self-feeding of a baby animal, said system comprising:
a nipple-topped nursing bottle;
an expandable fabric sleeve constructed and arranged to cover said nipple-topped nursing bottle, said expandable fabric sleeve including a collar substantially surrounding the nipple portion of said nipple-topped nursing bottle;
a squeezable toroidal donut shaped ring constructed and arranged to surround said expandable fabric sleeve;
one or more soft cylinders or rope like extensions detachably affixed to said squeezable toroidal donut shaped ring;
whereby said one or more soft cylinders or rope-like extensions may be formed into a support for said nipple-topped nursing bottle thereby positioning said nipple-topped nursing bottle where is may be accessed by the baby animal for nursing.

11. A system for feeding multiple baby animals, said system comprising:
a plurality of individual nipple-topped nursing bottles;
an expandable fabric sleeve constructed and arranged for covering each one of said individual nipple-topped nursing bottles, said expandable fabric sleeves including a collar substantially surrounding the nipple portion of said nipple-topped nursing bottle;
a squeezable toroidal donut shaped ring constructed and arranged to surround each of said expandable fabric sleeves,
one or more soft cylinders or rope-like extension detachably affixed to each of said squeezable toroidal donut shaped rings;
whereby said one or more soft cylinders or rope-like extensions may be used to cluster said plurality of nipple-topped nursing bottles together to allow substantially simultaneous feeding of multiple baby animals.

12. A bed for feeding multiple baby animals, said bed comprising a wall constructed and arranged to surround the bed;
a plurality individual nipple-topped nursing bottles, each individual bottle being covered by an expandable Fabric sleeve and surrounded by a squeezable toroidal donut shaped ring;
at least one soft cylinder or rope-like extension detachably affixed to each of said squeezable toroid donut shaped rings;
an attachment for connecting said soft cylinder or rope-like extension to the wall surrounding the bed.
